(19) United States
(12) Patent Application Publication
(10) Pub. No.: US 2008/0091775 A1
(43) Pub. Date: Apr. 17, 2008

(54) METHOD AND APPARATUS FOR PARALLEL OPERATIONS ON A PLURALITY OF NETWORK SERVERS

(75) Inventors: ZhePing WANG, Beijing (CN); Jun XU, Beijing (CN)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/870,479

(22) Filed: Oct. 11, 2007

(30) Foreign Application Priority Data
Oct. 12, 2006 (CN) 200610131819.7

(51) Int. Cl. G06F 15/16

(52) U.S. Cl. 709/203

(57) ABSTRACT

A method and apparatus for parallel operations on a network software product deployed on a plurality of network servers are disclosed, comprising the steps of: performing an operation on the network software product instance on one network server of the plurality of network servers; generating a first request to the network software product instance on the one network server based on the operation, and equivalent requests to the network software product instances on other network servers of the plurality of network servers; sending the first request to the network software product instance on the one network server, and sending the equivalent requests to the network software product instances on the other network servers; and receiving a response from the network software product instance on the one network server and responses from the network software product instances on the other network servers.

### CROSS-REFERENCE TO RELATED APPLICATIONS

This application claims the benefit of Chinese Patent Application No. 200610131819.7 filed 12 Oct. 2006 and which is hereby incorporated by reference.

### BACKGROUND

1. Field of the Invention

The present invention relates to the field of operations on a network software product, and in particular to a method and apparatus for parallel operations on a network software product deployed on a plurality of network servers.

2. Description of the Related Art

A network software product refers to an application deployed on a network server, which a user can access over networks such as the Internet or an intranet from a client, generally a conventional network client or client requesting software, to perform certain functions. Network software products are becoming increasingly popular, and now are widely used in the fields of webmails, online retails, online auctions, wikis, weblogs, Internet forums, online games, enterprise content management, and application service provider (ASP) etc. For example, IBM Records Manager from IBM Corporation is an electronic recording management application deployed on a web server.

With the continuous expansion of the demand for and application fields of network software products, the requirements for the correctness, effectiveness and performance of network software products are increasingly high, and the effective systematic testing of network software products has become an important subject for research.

Network software products adopt the B/S (browser/server) and C/S (client/server) architectures. In such architectures, a user interface can access an application in a server through a web browser or a client software, some business logics can be implemented in client in the B/S architecture, but the majority of the business logics in the two architectures are implemented in the server by invoking a database management system.

Correspondingly, during the testing of network software products, which generally includes functional test, performance test, availability test, client compatibility text, security test etc., operations need to be made at the client, requests be sent to the software product installed on a network server, and responses be obtained from the server, which are then evaluated.

Since network software products, when used as commercial products, generally need to support various operating systems, database systems, network application server systems, etc, and, combining these factors, there are in fact many types of supporting operation environments for a network software product. In addition, when testing a network software product, some functions need to be tested in many or even all environments.

Specifically, due to the limitation of testing resources, the majority of actual testing work will only be performed on some environments, and not on all environments. However, when a problem occurs during the testing, generally all the environments will be tested on, to determine which environments in all the environments are problematic and which are not. Since there are many schemas of permutations and combinations in view of the execution sequence for a software generally, in actual testing work, typically only several of the schemas will be tested, but when there occurs a problem in these several schemas, more combinations of the execution sequences will need to be tested in multiple environments, to determine to which factors the occurring problem is related, such as the execution environment, the execution sequence etc. In addition, when testing the network interface of a software product deployed on network servers, it needs to be tested whether the interfaces on multiple environments are consistent. For example, a software product supports various database servers, such as DB2, Oracle, etc., and though its interface is identical when installed with different databases, because its underlying implementations are different, for example, using different stored procedures on different database servers, and some problems will only be related to a certain database, all the situations will need to be tested.

In such a case, a series of the same or similar operations will need to be tested on a plurality of network servers with the same or similar appearances, such as logging on a network server, accessing some web pages, clicking on some links or buttons, filling in the forms in some web pages, submitting forms in some web pages, viewing the results of operations, etc.

Similarly, apart from the case of large-scale testing on a plurality of servers, when installing and maintaining large-scale servers, installation and maintenance personnel often have to do repetitive and batch works as well.

Since the same or similar operations need to be performed on the same or similar network servers, and the operation results need to be judged, this process is wholly or largely a repetitive work. If performed manually, albeit its advantage of flexibility, a large amount of time will be spent, and due to people's physical limitations, they will be fatigued, and human errors will probably be introduced. If an automatic operation tool (for example, an automatic testing tool, such as the Rational XDE Tester, Rational Functional Tester, ROBOT, etc.) is used to write an automatic operation script to be executed automatically on a plurality of network servers and the execution results are examined, albeit the advantage of multiple repetitive and batch executions, there are such disadvantages as high costs of writing and maintaining scripts, inconvenient modifications, only fixed execution sequences, incapability of satisfying all operation demands, etc. Further, when an automatic script is executed on multiple sites at the same time, a client will always be needed for each site, and operations will be performed on each client separately, thus occupying a large amount of resources and time.

Apparently, there is a need in the art for a method and apparatus for parallel operations on a network software product deployed on a plurality of network servers.

### SUMMARY OF THE INVENTION

The present invention provides a method and apparatus for, based on a user's operation on a software product on a network server, automatic parallel operations on the same (or similar) network software products deployed on a plurality of other network servers, in order to overcome the above mentioned deficiencies in the prior art.

In an aspect of the present invention, there is provided a method for parallel operations on a network software product deployed on a plurality of network servers, the method comprising: performing an operation on an instance of the network software product on one network server of the plurality of network servers; generating a first request to the network software product instance on the one network server based on the operation, and equivalent requests to the network software product instances on the other network servers of the plurality of network servers; sending the first request to the network software product instance on the one network server, and sending the equivalent requests to the network software product instances on the other network servers; and receiving a response from the network software product instance on the one network server and responses from the network software product instances on the other network servers.

According to another aspect of the invention, there is provided a method for testing a network software product, wherein a plurality of instances of the network software product are deployed on a plurality of network servers respectively, the method comprising the following steps: using the above method for parallel operations for testing a network software product to perform the testing operations.

According to another aspect of the present invention, there is provided an apparatus for parallel network operations on a network software product deployed on a plurality of network servers, the apparatus comprising: an interface module through which operations are performed on the network software product instance on one network server of the plurality of network servers; a generation module for generating a first request to the network software product instance on the one network server based on the operation, and equivalent requests to the network software product instances on the other network servers of the plurality of network servers; a sending module for sending the first request to the network software product instance on the one network server, and for sending the equivalent requests to the network software product instances on the other network servers; and a receiving module for receiving a response from the network software product instance on the one network server and responses from the network software product instances on the other network servers.

According to another aspect of the present invention, there is provided a system for testing a network software product, wherein a plurality of instances of the network software product are deployed on a plurality of network servers respectively, the system comprising: the above apparatus for parallel network operations for testing a network software product.

The present invention can also be embodied on a computer program product comprising a computer readable recording medium having computer readable code stored thereon, the code comprising computer executable instructions for implementing various steps of the above mentioned method for parallel network operations on a network software product deployed on a plurality of network servers.

The present invention have the following advantages: high efficiency, response results to multiple operations being obtained in one shot; no need of preparation, especially suitable for performing the same operation tasks, such as testing, installing, and maintenance etc., on large scale servers, or performing operations with a simple experiment nature; operational flexibility, the user being capable of judging by himself based on the returned results; avoiding human errors caused by repetitive operations; and no need to write automatic operation scripts, etc.

### BRIEF DESCRIPTION OF THE DRAWINGS

Characteristics believed to be novel in the present invention are set forth in the appended claims. The present invention itself, and the various modes of use, additional objects and advantages thereof can be best understood by referring to the following detailed description of illustrative embodiments when read in conjunction with the drawings, in which:

FIG. 1 is a schematic structural diagram of a system for performing operations on a network software product in the prior art;

FIG. 2 is a schematic structural diagram of a system for performing parallel network operations on a network software product deployed on a plurality of network servers according to an embodiment of the present invention;

FIG. 3 is a schematic structural diagram of a system for performing parallel network operations on a network software product deployed on a plurality of network servers according to another embodiment of the present invention;

FIG. 4 is a schematic block diagram of an apparatus for parallel network operations on a network software product deployed on a plurality of network servers according to an embodiment of the present invention, which can be included in a system as shown in FIG. 2;

FIG. 5 is a schematic block diagram of an apparatus for parallel network operations on a network software product deployed on a plurality of network servers according to another embodiment of the present invention, which can be included in a system as shown in FIG. 3;

FIG. 6 is a schematic block diagram of an apparatus for parallel network operations on a network software product deployed on a plurality of network servers according to still another embodiment of the present invention, which can be included in a system as shown in FIG. 2

FIG. 7 is a schematic flow diagram of an method for parallel network operations on a network software products deployed on a plurality of network servers according to an embodiment of the present invention; and

FIG. 8 is a schematic flow diagram of a method for parallel network operations on a network software products deployed on a plurality of network servers according to another embodiment of the present invention.

### DETAILED DESCRIPTION OF THE INVENTION

In the following, a method and apparatus for parallel network operations on a network software product deployed on a plurality of network servers, as well as a method and system for parallel testing of a network software product according to embodiments of the present invention are described. In the following description, for the purpose of illustration, numerous concrete and particular details are set forth in order for those skilled in the art to fully understand the present invention, it being obvious, however, that the present invention can be implemented without these details. In other cases, well-known structures and devices are shown in the form of block diagram, or are omitted, in order not to obscure the essential content of the present invention unnecessarily.

According to a method of the present invention, the user operates a network server at the front end, the user's requests to the network server are forwarded automatically to a plurality of other network servers with the same content at the background, and server responses are received from these servers. The responses received from these other servers are compared with the response received from the server that the front end user is accessing, and the comparison results are provided to the user. The user can know whether the responses of the other network servers and that of the network server that the user is accessing are consistent. In this way, while the user performs one operation on a network server, he can know whether the responses of other network servers accessed at the background are consistent with the response of the current network server.

In the following, embodiments of the present invention and the comparison between them and the prior art will be described with reference to the drawings.

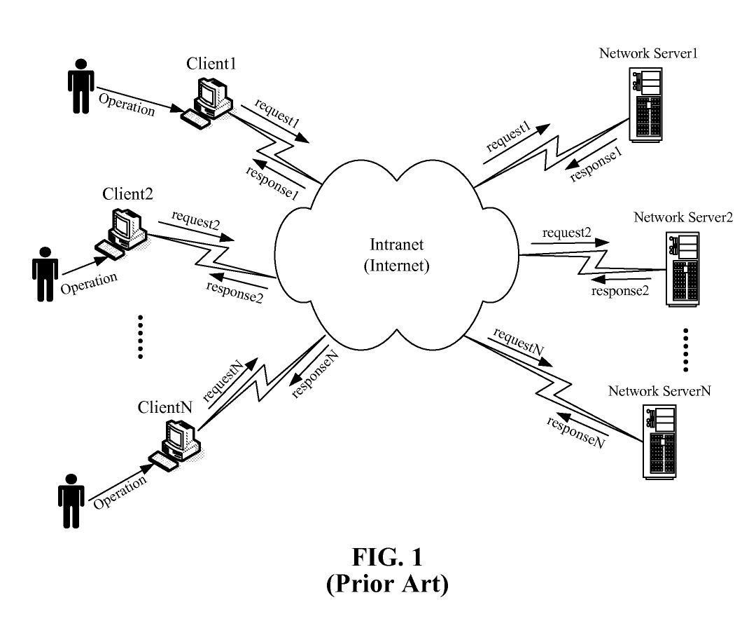

FIG. 1 is a schematic structural diagram of a system for operations on a network software product in the prior art. As shown, in the system, a plurality of instances of the network software product are deployed on a plurality of network servers 1, 2, . . . N respectively, and at the same time, a plurality of clients such as clients 1, 2, . . . N are used to perform operations. Such operations may include testing, installing, maintenance etc. In the case that the clients access the network servers through the TCP/IP protocols, the network servers are web servers; in the case that the clients access the network servers through the SMTP protocol, the network servers are mail servers; in the case that the clients access the network servers through the FTP protocol, the network servers are FTP servers; and so on. In operation, the network software product instances on the N network servers need to be operated through N clients respectively, wherein requests 1, 2, . . . N are sent to the network software product instances on the N network servers, which requests are transmitted to the respective network servers according to the address information contained therein via an intranet or the Internet. After each network server receives the network request, the network software product instance on the network server processes the network request, and returns the requested content in response, such as a web response containing text, images, etc. in the HTML format. The responses 1, 2, . . . N from the N network servers are transmitted to the respective requesting clients via the intranet or Internet, and presented by the clients on their GUIs to be viewed by the user. Alternatively, operations may also be performed on a single client instead of a plurality of clients, and in this case, operations need to be performed on the network software product instances on the N network servers at different times, wherein requests are sent to and responses received from them respectively. Such repetitive operations waste resources and time, thus increasing the operation costs; and when performed manually, may introduce errors, whereas when performed automatically through an automatic operation script, on the one hand the writing and maintenance of the operation script is difficult, on the other hand such a script is not applicable to all cases.

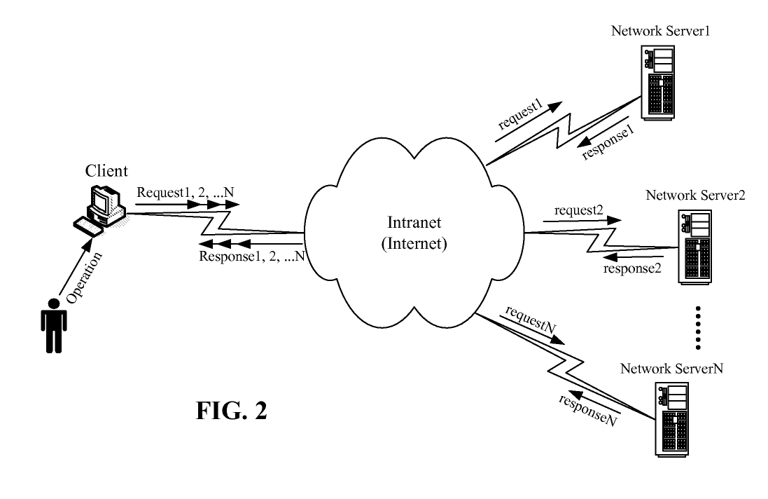

FIG. 2 is a schematic structural diagram of a system for parallel network operations on a network software product deployed on a plurality of network servers according to an embodiment of the present invention. As shown, in the structural diagram of the system for parallel web operations, a plurality of instances of the network software product to be operated are deployed on a plurality of network servers 1, 2, . . . N respectively, and only a single client is used to perform operations. As in the prior art, such operations include testing, installing, maintenance etc. In the case that the client accesses the network servers through the TCP/IP protocols, the network servers are web servers; in the case that the client accesses the network servers through the SMTP protocol, the network servers are mail servers; in the case that the client accesses the network servers through the FTP protocol, the network servers are FTP servers; and so on. The user performs operations on the network software product instance deployed on the network server 1. While a client browser or a client requesting apparatus sends the network request 1 generated from the operation to the network software product instance on the network server 1, it also automatically sends requests 2, . . . N equivalent to the request 1 to the network software product instances on each of the other network servers 2, . . . N. The requests 1, 2, . . . N are transmitted to the respective network servers 1, 2, . . . N via an intranet or the Internet. The network software product instance on each of the network servers 1, 2, . . . N processes the respective request, and returns the requested response content, such as the response content of a web request containing text, images, etc in the HTML format. The responses 1, 2, . . . N from the N network servers are transmitted to the client via the intranet or Internet, and a client browser or client requesting apparatus presents the content of the response from the network server 1 which it operates, and at the same time presents the contents of the responses from the other network servers 2, . . . N or the comparison results between the content of the response from the network server 1 and the contents of the other responses on the GUI to be viewed by the user.

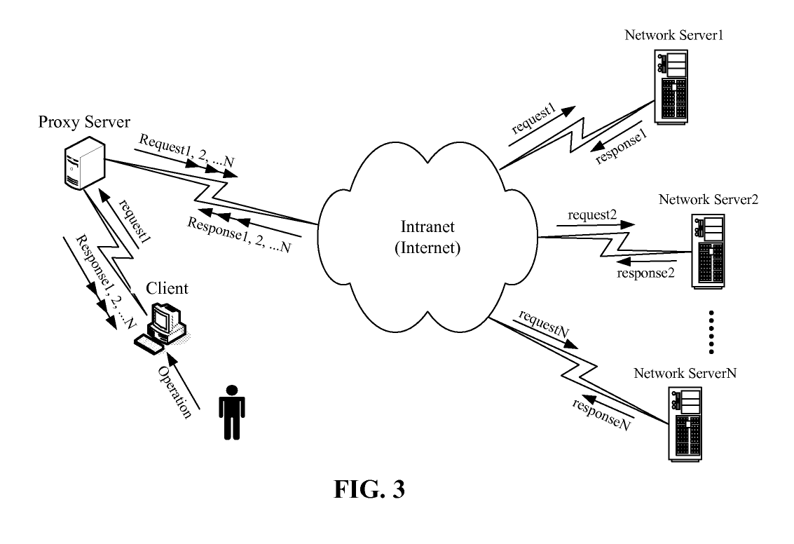

FIG. 3 is a schematic structural diagram of a system for performing parallel network operations on a network software product deployed on a plurality of network servers according to another embodiment of the present invention. As shown, in the structural diagram of the system for parallel network operations, a plurality of instances of the network software product to be operated are deployed on a plurality of network servers 1, 2, . . . N respectively, and only a single client is used to perform operations. Between the client and the servers are disposed a proxy server. The architecture is similar to that shown in FIG. 2, except that all requests of the client to the network servers 1, 2, . . . N and the responses from the network servers 1, 2, . . . N are transmitted through the proxy server, which can be an real proxy server or an virtual proxy server embedded in the client or a network server which acts as a proxy. In addition, the apparatus for parallel network operations on a network software product according to the present invention can either be included in the client, which the user operates on, or be included in the proxy server disposed between the client and the network servers, or even be included in an accessed network server.

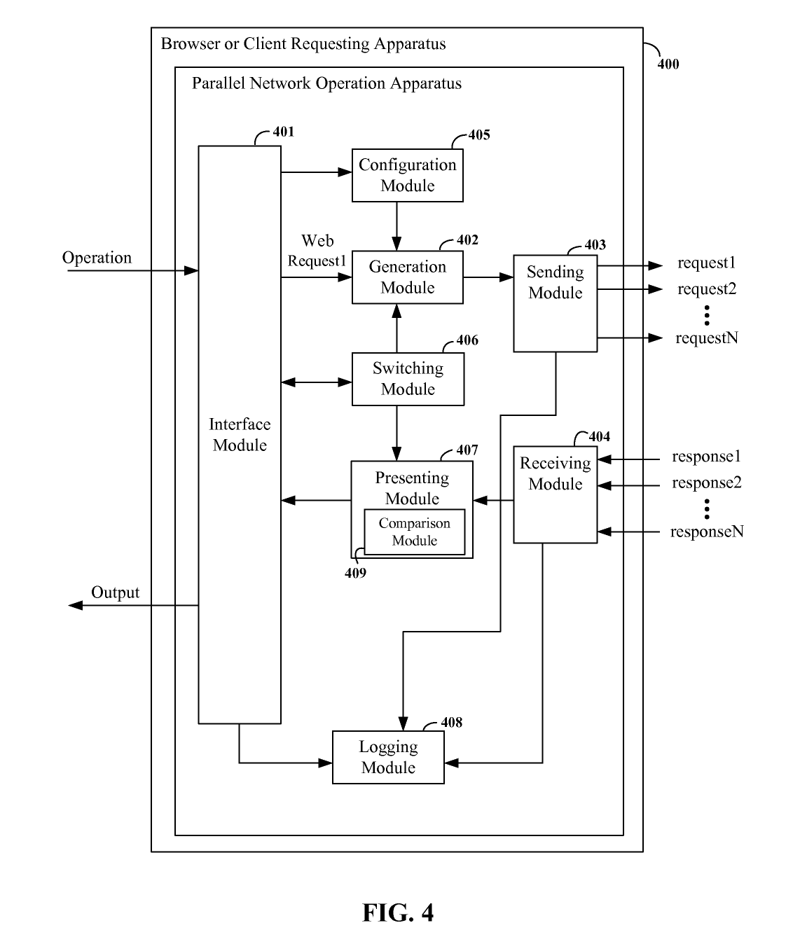

FIG. 4 is a schematic block diagram of an apparatus 400 for parallel network operations on a network software product deployed on a plurality of network servers according to an embodiment of the present invention, which can be included in a system as shown in FIG. 2. The apparatus 400 will be referred to as a parallel network operation apparatus for short hereinafter. The parallel network operation apparatus 400 can be implemented in the client computer system as shown in FIG. 2. In particular, the parallel network operation apparatus 400 can be implemented by a web browser or a client software apparatus running on the client computer system, that is, the modules of the parallel network operation apparatus 400 can be integrated into the browser or a client requesting module, or may be implemented by modifying existing modules in the client or by modifying the client requesting module.

The parallel network operation apparatus 400 can be used to send parallel operation requests to the instances of the same network software product deployed on the plurality of network servers, in order to perform parallel operations on the network software product instances deployed on the plurality of network servers. In one embodiment, the plurality of network servers provide different execution environments for the network software product, such as different network application server systems, different database management systems, different operating systems, or different hardware platforms.

As shown in the drawing, the parallel network operation apparatus 400 comprises: an interface module 401 through which an operation is performed on the network software product instance on one network server of the plurality of network servers; a generation module 402 for generating equivalent requests to the network software product instances on the other network servers of the plurality of network servers from the request to the network software product instance on the one network server, which is generated from the operation; a sending module 403 for sending the network request to the network software product instance on the one network server, and transmitting the equivalent requests to the network software product instances on the other network servers; and a receiving module 404 for receiving a response from the network software product instance on the one network server and responses form the network software product instances on the other network servers. In one embodiment, the parallel network operation apparatus 400 further comprises a presenting module 407 for presenting the response from the instance of the network software on the one network server and the responses from the network software product instances on the other network servers. In one embodiment, the parallel network operation apparatus 400 further comprises a comparison module 409 for comparing the response from the network software product instance on the one network server and the responses from the network software product instances on the other network servers, and providing the comparison results to the presenting module 409, and the interface module 409 is further configured to provide the comparison results, such as detailed information on whether the plurality of responses are consistent etc. In FIG. 4, the comparison module 409 resides within the presenting module 407, but in other implementations, the comparison module 409 can also be a separate module coupled to the presenting module 407 and the receiving module to perform the same function.

In one embodiment, the parallel network operation apparatus 400 is used for manual operations, and in this case, the interface module 401 is a user interface module through which the user performs manual network operations on the network software product instance deployed on the network server as presented by the user interface, for manual testing, installing, maintenance etc. Alternatively, the parallel network operation apparatus 400 can also be used for automatic operations, and in this case, an automatic operation tool will be closely integrated with the parallel network operation apparatus 400 of the present invention, and perform automatic network operations through the interface module 401 with an automatic operation script.

The user or the automatic operation tool performs an operation on the network software product instance on the network server through the interface module 401, such as logging on the network server, accessing some web pages, clicking on some links or buttons, filling in and submitting forms on some web pages etc. Such an operation are translated (e.g., through a translation module not shown) by a client web browser or client requesting apparatus into a request to the network software product instance on the network server, which request is transferred to the generation module 402. The generation module 402 generates equivalent requests to the network software product instances on one or more other network servers based on the received request to the network software product instance on the network server, and transfers the original request and the generated one or more equivalent requests to the sending module 403. Then, the sending module 403 sends the original request and the generated equivalent requests to instances of the network software product on the original network server and on the one or more other network servers respectively through the network. Alternatively, the original request can also be provided to the sending module 403 while being provided to the generation module 402, and after the generation module 402 generates the equivalent requests based on the original request and provides them to the sending module 403, the sending module 403 sends the original request and the equivalent requests to the original network server and the other network servers respectively through the network.

In the above implementation, the generation module 402 and the sending module 403 are separate modules and the sending module 403 can be the existing sending module in the web browser or the client requesting apparatus. In another implementation, the generation module 402 can be integrated into the sending module 403 as part thereof, and the sending module is a sending module specifically used for the present invention, which can be obtained by modifying the sending module in an existing browser or a client requesting apparatus, or by creating a new sending module.

As understood by those skilled in the art, generating a plurality of equivalent requests to the network software product instances on the other network servers based on the original request to the network software product instance can be achieved easily by modifying the URL or IP address in the original request or using other methods.

The original request and the equivalent requests are transmitted to the network software product instances on the respective network servers through the communication interface of the client computer system on which the network browser or client requesting apparatus resides, communication links, and an intranet or the Internet etc. The network software product instances on the network servers process the respective requests, generating network responses containing contents such as HTML text, images etc., and send back the responses through the intranet or Internet, communication links, communication interface etc. to the network browser or client requesting apparatus. The receiving module 404 in the network browser or client requesting apparatus receives the network responses from the network software product instances on the network servers, and provides the network responses to the interface module 401, in order to be provided to the user or otherwise processed. In an embodiment of the present invention, the network response from the network software product instance on the original network server on which the network browser or client requesting apparatus performed the operation and the network responses from the network software product instances on the other network servers are provided together to the interface module 401, which then provides them to the user for judging the responses to the operation from the instances of the software product on the network servers, so as to obtain the information on the functions, performance, availability, security etc. of the network software product on the different execution environments of the network servers. In another embodiment of the present invention, the network response from the network software product instance on the original network server on which the browser or client requesting apparatus performed the operation is provided (directly or through the presenting module) to the interface 401, which provides it the user, while the network response from the network software product instance on the original network server and the network responses from the instances of the software product on the other network servers are provided together to the comparison module 407. The comparison module 407 compares the network response from the network software product instance on the original network server and the network responses from the network software product instances on the other network servers, obtaining the comparison results indicating their similarities and differences, and provides the comparison results to the interface module 401. The interface module 401 presents the comparison results to the user for judging the similarities and differences between the response from the network software product instance on the original network server and the responses from the network software product instances on the other network servers, so as to obtain the information on the functions, performance, availability, security etc. of the network software product on the different execution environment of the network servers.

The comparison module 409 can either be configured to compare the data of the responses, or be configured to compare the visual displays of the interfaces generated from the responses, or be configured to compare both the data of the responses and the visual displays.

In the case that the comparison module 409 is configured to compare the visual displays of the interfaces generated from the responses, the display interfaces of the network software product instances on the network servers may be generated, and the multiple browser display interfaces may be displayed in multiple windows through the interface module 401, or the interfaces of the multiple results may be displayed by the client requesting apparatus, for human judging; alternatively, after generating the display interfaces of the network software product instances on the network servers, instead of displaying all the interfaces, the comparison module 409 compares the similarities between the displayed images point by point, and provides the comparison results to the user through the interface module 401.

In the case that the comparison module 409 is configured to compare the data of the responses, all the contents of the data files returned from the network software product instances on the network servers can be compared. The comparison module 409 can automatically filter out URL related differences. The time order of the returning can also be considered, but usually the time order is only used for reference.

Alternatively, after the display interfaces of the network severs or multiple result interfaces to be displayed by the client requesting apparatus are generated, the comparison module 409 can identify various display objects and controls (e.g., buttons, entry fields, text, forms, etc.) in the interfaces to compare. In this intelligent comparison method, some mapping relations can be set manually to assist the comparison module 409 to better map a plurality of interfaces. For example, a form in an interface in a path on server A corresponds to a form on server B. Such mapping relationships can be customized, stored, loaded, modified, deleted etc. As such, if many comparison operations are performed on some fixed network servers, by customizing some such mapping relations, many subsequent comparison operations can be performed conveniently. Such a method also extends further the application scope of the apparatus 400 of the present invention. For many not very similar or completely different network servers, many comparison operations can also be performed on the contents at some relatively fixed positions thereon using the apparatus 400 of the present invention. For example, the apparatus 400 of the present invention 400 can be used to compare the information of a stock on two different web sites. Although the formats on the web sites may be completely different, by setting such mapping relationships, the apparatus 400 of the present invention can automatically extract the stock price data with the same meaning on the two web sites, so that the comparison can be achieved. If periodic refreshing and detection functions are further implemented, the apparatus 400 can be used to monitor many data with corresponding relationships. For example, if two peer web sites with high availability are detected (the two web sites running simultaneously, one as a formal web site, the other as a backup. When the formal web site fails, operations automatically switch to the backup web site), when some key information of the two web sites are inconsistent, some actions may be taken. This is also similar to a “web site anti-tampering system”.

According to a one embodiment of the present invention, the parallel web operation apparatus 400 further comprises a configuration module 405 for specifying the one network server on which the instance of the network software is to be operated and the other network servers on which the instances of the network software the equivalent request are to be transmitted to, that is, for setting the address of the network server to be operated on currently and the addresses of the network servers to be accessed on the back end.

In one embodiment, the user performs the setting operations on the configuration module 405 through the interface module 401. Of course, the user can also perform the setting operations on the configuration module 405 through a user interface of the configuration module 405 itself.

In one embodiment, before performing parallel network operations on the network software product deployed on the plurality of network servers, the configuration module 405 is used to set the address of the network server to be operated on currently and the addresses of the network servers to be accessed on the back end; alternatively, during performing parallel operations on the network software product deployed on the plurality of network servers, the configuration module 405 can also be used to re-set the address of the network server to be operated currently and the addresses of the network servers to be accessed on the back end. The configuration module 405 can be used to set all or part of the network servers on which instances of the network software product have been deployed, as the network servers to be accessed on the back end. As will be understood by those skilled in the art, the configuration module 405 can specify the one network server on which the network software product instance is to be operated on and the other network servers on which the instances of the network software product the equivalent requests are to be transmitted to, by specifying the IP addresses of the network servers, specifying the URL of the network servers, etc.

In an embodiment of the present invention, the setting results of the configuration module 405 are provided to the generation module 402, which, according to the addresses of the network servers to be accessed on the back end as specified in the setting results, and based on the received request to the network software product instance on the network server being currently operated on, generates equivalent requests to the network software product instances on the one or more other network servers to be accessed on the back end, and transfers the original request and the generated one or more equivalent requests to the sending module 403, which then sends them respectively to the network software product instances on the network server being currently operated on and the plurality of other specified network servers.

According to an embodiment of the present invention, the parallel network operation apparatus 400 further comprises a switching module 406, which can be used to switch operations to an asynchronous mode in which the apparatus 400 of the present invention will not automatically generate the requests equivalent to the original request and send them to the network software product instances on the other network servers on the backend, instead it will perform separate operations on an individual target network server, just as operations in a normal network browser. In addition, the switching module 406 further can be used to switch operations from the asynchronous mode back to the synchronous mode, that is, the mode in which the program sends parallel equivalent requests on the back end as describe above.

In one embodiment, the switching module further can be used to switch the network server being currently operated on in the synchronous mode or the asynchronous mode to another network server in the plurality of network servers as set by the configuration module 405. In this way, the apparatus 400 can switch to displaying responses returned from the other network servers at any time, and operating on the other network servers.

While it is described in the foregoing that a single switching module 406 performs both the function of switching between the synchronous mode and the asynchronous mode, and the function of switching the currently operated network server in the synchronous mode or the asynchronous mode, those skilled in the art will understand that the two functions could also be performed be two separate switching modules.

In one embodiment, the user performs switching operations on the switching module 406 through the interface module 401. Of course, the user can also performs switching operations on the switching module 406 through the user interface of the switching module 406 itself.

When the interfaces of the network software product instances on the plurality of network servers accessed by the user are different, or the data of forms to be filled in are different etc, the parallel operation apparatus 400 according to the present invention can switch to the asynchronous mode. Thus, the request generated from a network operation entered by the user on the front end will not be transmitted to the other network servers. The user can switch the network server operated on the front end to one of the other network servers, and after the specific information is entered, switch to another network server to continue the entry. In addition, when the specific information on all the network servers have been entered, the user can switch back to the synchronous mode, to continue to perform identical operations on the plurality of network servers.

According to an embodiment of the present invention, the parallel network apparatus 400 further comprises a logging module 408 for logging the operations the user performs on the network software product instance on the current network server, and/or logging requests to the network software product instances on the network servers and/or responses from the instances of the network software product on the network servers.

The logs include a network server accesses log and a user operations log. The network server accesses log records accesses to the network software product instances on the network servers, and received results. The granularity of the recording can be adjusted, with the most granular for recording every bit returned from the network software product instances on the network servers. In this way, according to the comparisons in the log, the description of the similarities between the network software product instances on a plurality of network servers can be further provided. For example, if the results returned from the network software product instances on two network servers under the same user operations appear to be the same, but the results returned from some hidden fields on the web pages are not the same, this difference can be discovered by comparing the detailed log. Thus, the application scope of the apparatus 400 of the present invention can be extended. On the other hand, the user operations log is used to recording all user operations for later reference.

It should be noted that the various modules in the parallel network operation apparatus 400 according to the embodiments of the present invention as described above are only exemplary and illustrative, and are not intended to limit the scope of the present invention. In other embodiments of the apparatus for parallel network operations on a network software product deployed on a plurality of network servers, there can be different modules, some of the modules described above may be lacking, or some other modules may be added; the functions of some of the modules described above can be combined into a single module, or be distributed into a plurality of new modules; the linking relationships between the modules described above may change; and the name of the modules may change. All these variations are within the scope of the present invention, provided only that these modules together can implement the essential concept of the present invention, that is, automatically generating and transmitting a plurality of equivalent network operation requests to the instances of a network software product on a plurality of network servers based on a network operation request. For example, the generation module 402 can be incorporated into a request generation module for generating a request to the network software product instance on the one network server based on an operation of the user, and equivalent requests to the network software product instances on the other network servers.

In an embodiment of the present invention, for the B/S architecture, the apparatus 400 for parallel network operations on a network software product deployed on a plurality of network servers is implemented as a plug-in of a network browser, that is, the various modules described above of the parallel network operation apparatus 400 are integrated into an existing network browser, and combine with the functions of the various modules in the existing network browser, or modify the functions of the various modules in the existing network browser, so as to enable the existing network browser to implement the functions of the present invention in addition to its original functions. Because such an embodiment fully utilizes the functions of the existing browser such as browsing, without the need to re-create a new browser, and utilizes the plug-in interface generally provided with an existing browser to implement the functions according to the present invention. Of course, this is not a limitation to the present invention.

In another embodiment of the present invention, for the B/S architecture, the parallel network operation apparatus 400 is implemented as a separate network browser. That is, a new network browser is re-created, which, in addition to having the functions of a normal browser such as browsing, further has the functions of the various modules described above of the present invention. In this way, the various functions of the present invention can be closely integrated with the conventional functions of the network browser, thus facilitating more completely and better implementing the functions of the present invention.

In still another embodiment of the present invention, for the B/S architecture, the parallel operation apparatus 400 is implemented as a network browser with the IE core. That is, a new network browser with the functions according to the present invention is created based on the IE network browser core. Because the IE network browser core is employed, the creation of the new network browser is greatly facilitated, and at the same time, because the functions of the present invention is closely integrated into the new network browser, the functions according to the present invention can be more completely and better implemented.

In yet another embodiment of the present invention, for the C/S architecture, the parallel network operation apparatus 400 is implemented as a plug-in to a client-requesting program, or is combined directly with the client-requesting program.

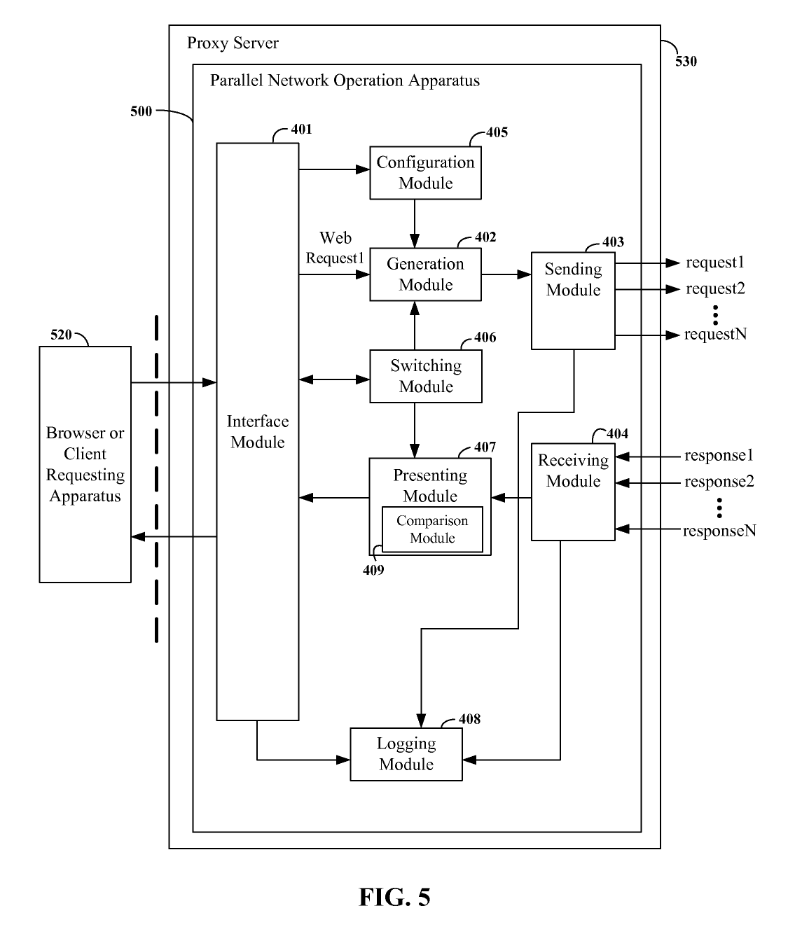

As an alternative, FIG. 5 illustrates a schematic diagram of an apparatus 500 for parallel operations on a network software product deployed on a plurality of network servers according to another embodiment of the present invention, which can be included in a system as shown in FIG. 3. Hereinafter, the apparatus 500 will be referred to as the parallel network operation apparatus 500 for short. In this embodiment, the parallel network operation apparatus 500 is implemented by a proxy server, that is, the various modules of the parallel network operation apparatus 500 reside in the proxy server for the most part.

As shown, the parallel network operation apparatus 500 can be implemented in a proxy server connected with the client computer system as shown in FIG. 3. Specifically, the parallel network operation apparatus 500 In one embodiment can be implemented through software running in the proxy server, that is, when the software is running in the proxy server, the software combines with hardware modules of the proxy server to form the various modules of the parallel network apparatus 500.

The proxy server 500 is positioned between the client computer system 520 on which network operations are performed by the user and a plurality of network servers. The parallel network operation apparatus 500 can be implemented in the proxy server 530, and the various modules of the parallel network operation apparatus 500 are generally similar to those of the parallel network operation apparatus as shown in FIG. 4, wherein like reference numerals denote like elements. The difference lies in the locations of implementation, with one being implemented in a browser or a client requesting apparatus, the other being implemented in the proxy server. Since the various modules of the parallel network operation apparatus and their functions have been described in detail above in relation to the embodiment as shown in FIG. 4, they will be omitted here.

It should be noted that the various modules of the parallel network operation apparatus 500 according to the embodiment of the present invention as described above are only exemplary and illustrative, and not intended to limit the present invention. In other embodiment of the parallel network operation apparatus 500 according to the present invention, there may be different modules, some of the modules described above may be lacking, or other modules may be added; the functions of some of the modules described above may be combined into a single module, or be distributed in a plurality of new modules; the linking relationships between the modules described above may change; and the name of the various modules may change. Provided only that these modules together can realize the basic idea of the present invention, that is, a proxy server automatically generates and transmits a plurality of equivalent network operation requests to the instances of the same network software product on a plurality of network servers based on a network operation request from a client computer system, these variations are all within the scope of the present invention. For example, the generation module 502 can be incorporated into a request generation module for generating a request to the network software product instance on the one network server and equivalent requests to the network software product instances on the other network servers based on the user's operation.

In an embodiment of the present invention, the various modules of the parallel network operation apparatus 500 on the proxy server can be integrated into an existing proxy server by various means, such as, in the form of plug-ins, to combine with the functions of modules of the existing proxy server, or modifying the functions of modules of the existing proxy server, so that the existing proxy server can implement the functions of the present invention in addition to its original functions. Since this embodiment utilizes substantially functions of the existing proxy server, without need to re-create a new proxy server. Alternatively, a separate proxy server may be implemented. Moreover, as can be understood by those skilled in the art, a proxy server is only an implementation of a proxy, and the proxy apparatus can be embedded into a client system, or even embedded into a network server, which will then act as a proxy server. Of course, this is not a limitation to the present invention.

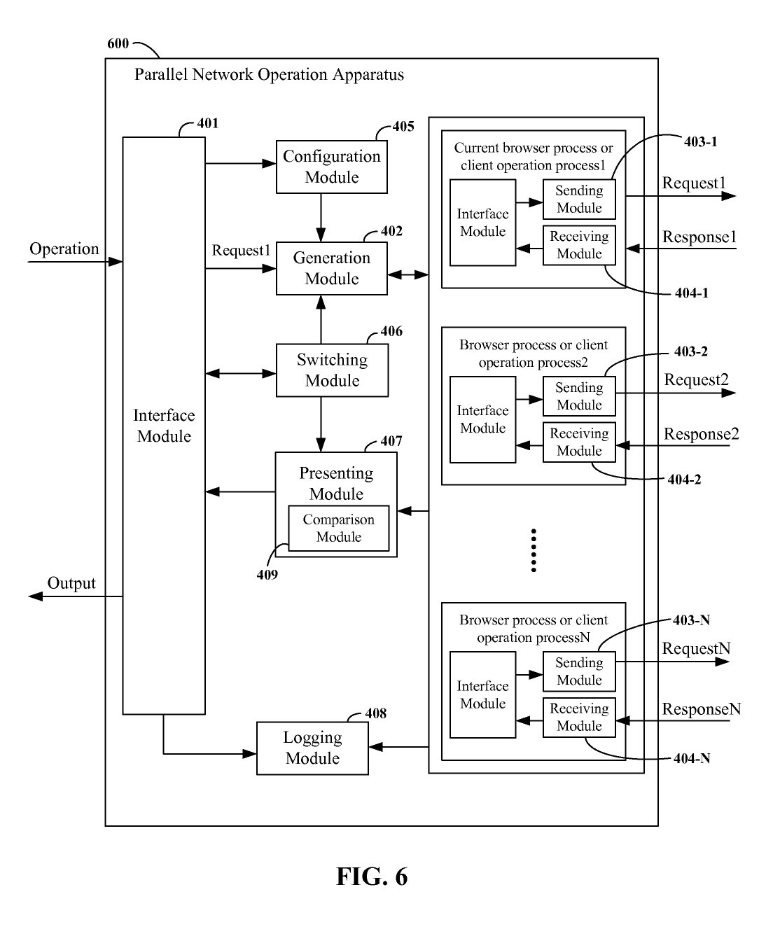

FIG. 6 is a schematic diagram of the parallel network operation apparatus according to another embodiment of the present invention, which can be included in the system as shown in FIG. 2. The parallel network operation apparatus 600 can be implemented in a client computer system shown in FIG. 2. The parallel network operation apparatus 600 can be used to perform parallel operations on the instances of the same network software product deployed on a plurality of network servers, in order to test in parallel the network software product instances deployed on the plurality of network servers.

As shown, the parallel network operation apparatus 600 comprises the following components of the parallel network operation apparatus in FIG. 4: the configuration module, switching module, presenting module, interface module and logging module, with the same reference numerals and the same functions as those in FIG. 4. In one embodiment, the generation module of the parallel operation apparatus 600 is further configured to create a separate browser process or client operation process for each network server in the plurality of network servers that needs to be operated on, which, in the case of B/S architecture, is to create a browser process, and in the case of C/S architecture, is to create a client operation process. And the generation module generates a request to the network software product instance on the one network server and equivalent requests to the network software product instances on the other network servers in the plurality of network servers in the following manner: intercepting an operation performed through the I/O device on the network software product instance on the one network server in the plurality of network servers that need to be operated on, converting the operation into virtual operations on the network software product instances on the other network servers in the plurality of network servers that need to be operated on, providing the operation to the network browser process or client operation process corresponding to the one network server, and providing the virtual operations to the network browser processes or client operation processes corresponding to the other network servers, for processing by the network browser processes or client operation processes in order to obtain network outputs.

In one embodiment, processing the operation and the virtual operations by the corresponding network browser processes or client operation processes respectively in order to obtain the network output and virtual network outputs comprises the corresponding network browser processes or client operation processes generate requests based on the operation and virtual operations respectively, and the sending modules (403-1, 403-2, . . . 403-N) of the respective browser processes or client operation processes sending respectively the generated requests to the network software product instance on the one network server and to the network software product instances on the other network servers; the receiving modules (404-1, 404-2, . . . 404-N) of the corresponding network browser processes or client operation processes receive the response from the network software product instance on the one network server and the responses from the network software product instances on the other network servers respectively; and the corresponding network browser processes or client operation processes generate the network output and the virtual network outputs based on the responses respectively.

It should be noted that the parallel network operation apparatus 600 according to this embodiment of the present invention can be used to manipulate not only the behavior of the network software product on the network server, but also the behavior of the network software product on the client, such as those behavior performed by a JavaScript client script.

The I/O device can comprise any one or more input devices such as a keyboard, mouse, stylus, etc. and one or more output devices such as a monitor, printer, etc. The user can operate the parallel network operation apparatus through the input devices, and receive the response results from the network software product instances deployed on a plurality of network servers through the output devices, thereby operating the network software product.

The plurality of network browser processes or client operation processes can be created either when the parallel operation apparatus 600 according to the embodiment of the present invention starts to run, or after a plurality of network servers needing to be operated on are specified as described below, or when the parallel operation apparatus 600 receives for the first time the user's request to the network software product instance on the one network server being currently operated on. In one embodiment, the network browser processes or client operation processes are created through invoking the same network browser program by the generation module 402. Each of the network browser processes or client operation processes, as an independently running network browser or client operation program, has the functions and modules of a complete network browser or client operation program, such as processing network operations, sending requests and receiving network responses, etc.

In other embodiments of the present invention, the comparison module 409 can be configured to specify objects and controls in the display interfaces of the network outputs and the virtual network outputs, and perform comparison based on the mapping relationships between the objects and controls in the interfaces. In such an embodiment, the generation module 402 in one embodiment further comprises a module for setting the mapping relationships, wherein the set mapping relationships can be customized, stored, loaded, modified, and deleted. In other embodiments of the present invention, the comparison module 409 does not compare the display interfaces of the network output and the virtual network outputs, instead the presenting module 407 provides the display interfaces of the network output and the virtual network outputs to the I/O device through the interface device 409 for manual comparison by the user.

In the foregoing, the apparatus for parallel operations on a network software product deployed on a plurality of network servers according to embodiments of the present invention. It should be noted that the described embodiments are only exemplary implementation of the system and apparatus of the present invention, and do not imply that the present invention is limited to only these particular implementations. Rather, with the benefit of the description, those skilled in the art can easily contemplate other embodiments of the system and apparatus of the present invention.

It should be noted that the various modules of the parallel network operation apparatus 600 according to the embodiment of the present invention are only exemplary and illustrative, and not intended to limit the present invention. In other embodiments of the parallel network operation apparatus 600 according to the present invention, there may be different modules, some of the modules described above may be lacking, or other modules may be added; the functions of some of the modules described above can be combined into a single module, or be distributed in a plurality of new modules; the linking relationships between the modules described above may change; and the names of the various modules may change. All of these variations are within the scope of the present invention.

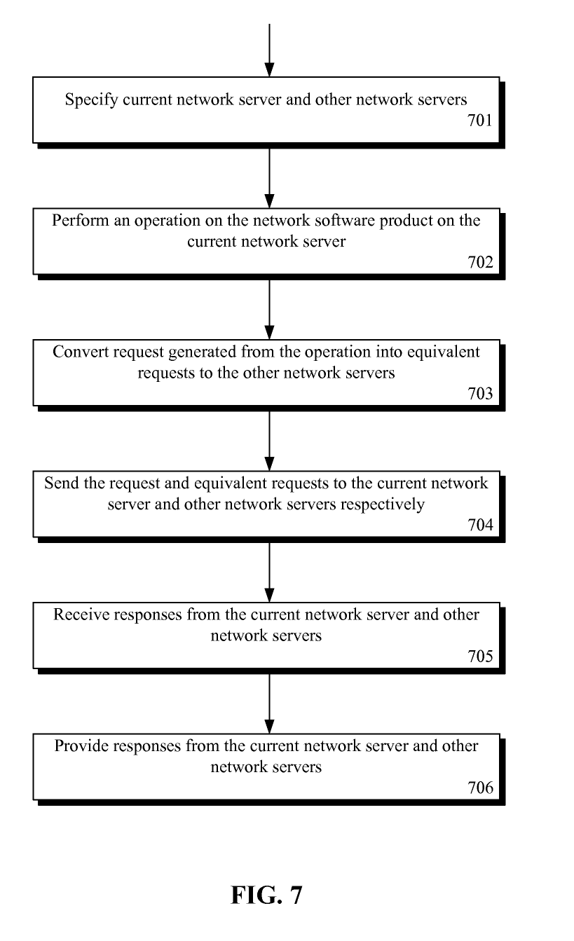

In addition, based on the above description, those skilled in the art can readily obtain a method for testing a network software product of the present invention and a method for parallel operations on a network software product deployed on a plurality of network servers. FIG. 7 is a flow diagram of a method for parallel operations on a network software product deployed on a plurality of network servers according to an embodiment of the present invention. The various steps in the method for parallel operations on a network software product deployed on a plurality of network servers according to an embodiment of the present invention will be described briefly below with reference to FIG. 7, and for the detailed particulars of each steps, reference can be made to the above descriptions of various modules in the system for testing a network software product and those in the parallel network operation apparatus 400, 500 according to embodiments of the present invention.

As shown in FIG. 7, the method for parallel operations on a network software product deployed on a plurality of network servers comprises the following steps:

In step 701, the current network server on which the network software product instance is to be operated and the other network servers on which the network software product instances the equivalent requests are to be transmitted to are set respectively;

In step 702, at the client, an operation is performed on the network software product instance on the current network server in the plurality of network servers;

In step 703, the request to the network software product instance as generated from the operation is converted into equivalent requests to the network software product instances on the other network servers.

In step 704, the request to the network software product instance is transmitted to the network software product instance on the current network server, and the equivalent requests are automatically transmitted to the network software product instances on the other network servers.

In step 705, the response from the network software product instance on the current network server and the responses from the network software product instances on the other network servers are received; and

In step 706, the response from the network software product instance on the current network server and the responses from the network software product instances on the other network servers are provided.

In one embodiment, the method for parallel operations on a network software product deployed on a plurality of network servers further comprises the step of comparing the response from the network software product instance on the current network server and the responses from the network software product instances on the other network servers, and the step of providing comprises providing the comparison results.

In one embodiment, the method for parallel operations on a network software product deployed on a plurality of network servers further comprises the step of switching to an asynchronous mode, in which the program will not automatically transmit the equivalent requests to the network software product instances on the other network servers; and the step of switching back from the asynchronous mode. And in one embodiment, the method for parallel operations on a network software product deployed on the network server further comprises the step of switching the current network server on which the network software product instance is to be operated on to another network server in the plurality of network servers both in the synchronous mode and in the asynchronous mode.

In one embodiment, the method for parallel operations on a network software product deployed on the plurality of network servers further comprises the step of logging the operation and/or logging the requests to the network software product instances on the various network servers and/or the responses from the network software product instances on the various network servers.

In one embodiment, the comparison step further comprises either or both of comparing the data of the responses and comparing the visual displays of the interfaces generated from the responses.

In one embodiment, the plurality of network servers provide different execution environments for the network software product.

In one embodiment, the operation is performed by the user manually, and the step of providing comprises presenting the response from the network software product instance on the one network server and the responses from the network software product instances on the other network servers to the user.

In one embodiment, the method is implemented by any of a plug-in of a network browser, a separate network browser, a network browser using the IE core, and plug-ins of a client requesting apparatus and/or a proxy server.

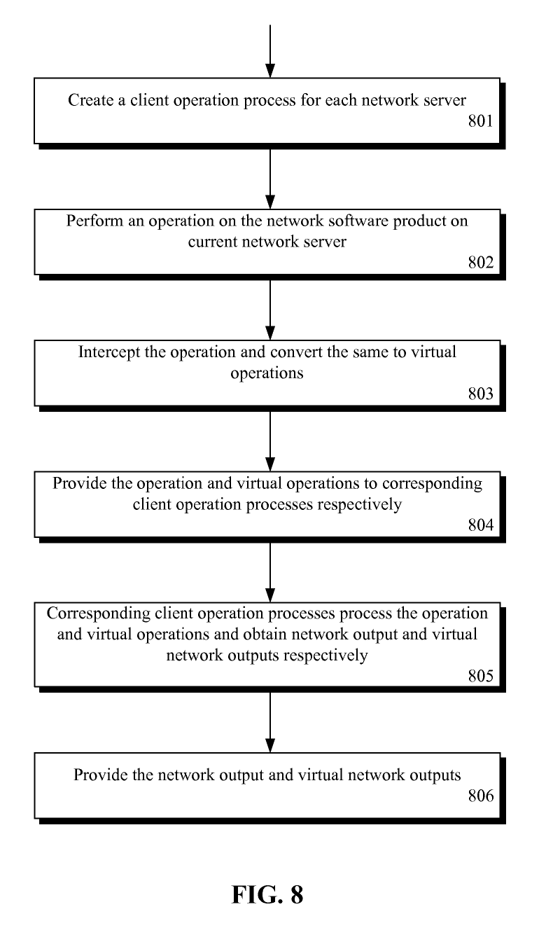

FIG. 8 illustrates a flow diagram of a method for parallel operations on a network software product deployed on a plurality of network servers according to another embodiment of the present invention. The various steps in the method for parallel operations on a network software product deployed on a plurality of network servers according to the embodiment of the present invention will be described briefly below with reference to FIG. 8, and for the detailed particulars of each steps, reference can be made to the above descriptions of various modules in the system for testing a network software product and those in the parallel network operation apparatus 600 according to embodiments of the present invention.

As shown in FIG. 8, the method for parallel operations on the network software product deployed on the plurality of network servers comprises the following steps:

In step 801, at the client, a separate network browser process or client operation process is created for each network server in the plurality of network servers on which an instance of the network software product is installed and operations are to be performed on, the processes being a network browser process in the B/S architecture, and a client operation process in the C/S architecture.

In step 802, an operation is performed on the network software product instance on the one network server in the plurality of network servers that needs to be performed on.

In step 803, the operation is intercept, and converted into virtual operations on the network software product instances on the other network servers in the plurality of network servers that need to be operated on.

In step 804, the operation is provided to the network browser process or client operation process corresponding to the one network server, and the virtual operations are provided to the network browser processes or client operation processes corresponding to the other network servers.

In step 805, the corresponding network browser processes or client operation processes respectively process the operation and the virtual operations to obtain a network output and virtual network outputs; and

In step 806, the network output and the virtual network outputs are provided.

In one embodiment, the step of respectively processing the operation and the virtual operations by the corresponding network browser processes or client operation processes to generate the network output and the virtual network outputs comprises: the corresponding network browser processes or client operation processes generate requests based on the operation and the virtual operations respectively, and provide the requests to the network software product instances on the one network server and the other network servers; the corresponding network browser processes or client operations processes receive the response from the network software product instance on the one network server and the responses from the network software product instances on the other network servers; and the corresponding network browser process or client operation processes generate the network output and the virtual network outputs based on the responses respectively.

In one embodiment, the step of parallel operations on a network software product deployed on a plurality of network servers further comprises the step of comparing the output and the virtual outputs and providing the comparison results, the step of specifying the other network servers that need to be operated on and the one network server on which the network software product instance is to be operated, the step of switching to an asynchronous mode, and the step of switching the one network server on which the network software product instance is to be operated to any one of the other network servers, the step of logging the operation and the virtual operations and/or logging one or more of the corresponding requests, the responses from the network software product instances on the various network servers, and the output and virtual outputs of the various network browser processes, the step of setting mapping relationships used in the comparison, the detailed descriptions of all of which can be found in the above description of the parallel network operation apparatus 600 according to an embodiment of the present invention.

In one embodiment, the operation is performed manually by the user, and the step of providing comprises presenting the network output and the virtual network outputs or the comparison results between the two to the user.

In one embodiment, the browser processes are created by invoking the same common network browser program.

In the foregoing, the flow of the method for parallel operations on a network software product deployed on a plurality of network servers according to embodiments of the present invention has been described. As will be understood by those skilled in the art, the various steps are only illustrative of the present invention, and are not intended to limit the present invention. In other embodiments of the present invention, some of the steps may be omitted or replaced, some new steps may be added, some of the steps may be combined together, some of the steps may be further split into multiple steps, some of the steps may be performed in parallel, or performed in a different order. For example, the method for parallel operations may further comprise a step of generating requests, which generates the request to the network software product instance on the one network server and the equivalent requests to the network software product instances on the other network servers based on the network operation of the user. As will be understood by those skilled in the art, the step can be embodied in the above converting step, intercepting step, providing step, etc, or in other words, implemented by these steps. Provided only these variants implement the basic idea of the present invention, that is, automatically generating and transmitting a plurality of equivalent network requests to the same network software product on a plurality of network servers based on a network operation request from the client, these variants are all within the scope of the present invention.

In another aspect of the present invention, a method for testing a network software product is further provided, the step comprising the following steps: deploying a plurality of instances of the network software product on a plurality of network servers; and performing test operations using the above method for parallel operations for testing a network software product.

The various components of the client computer system on which the method and apparatus for parallel operations for testing a network software product are within the knowledge of those skilled in the art.

The present invention relates to a method and apparatus for parallel operations on a network software product deployed on a plurality of network servers. According to an embodiment of the present invention, the various steps of the method is performed by execution of a series of instructions contained in a main memory by a processor, and the various execution components are also within the knowledge of those skilled in the art. In alternative embodiments, hard-wired circuits can be used in place of or in addition to the computer software instructions to implement the present invention. Thus, the embodiments of the present invention are not limited to any particular combination of hardware circuits and software.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods.

Although the present invention has been described and illustrated with reference to its various embodiments, those skilled in the art will understood that variations in form and details can be made therein without departing from the spirit and scope of the present invention; and reference should be made to the appended claims for determining the scope of the present invention.

1. A method for parallel operations on a network software product deployed on a plurality of network servers, comprising the steps of:
performing an operation on an instance of the network software product on one network server of the plurality of network servers;
generating a first request to the network software product instance on the one network server based on the operation, and equivalent requests to the network software product instances on other network servers of the plurality of network servers;
sending the first request to the network software product instance on the one network server, and sending the equivalent requests to the network software product instances on the other network servers; and
receiving a response from the network software product instance on the one network server and responses from the network software product instances on the other network servers.

2. The method as recited in claim 1, further comprising the steps of:
creating a separate browser process or client operation process for each network server of the plurality of network servers that needs to be operated on;
wherein, the step of generating comprises:
intercepting the operation, and converting the operation into virtual operations on the network software product instances on the other network servers of the plurality of network servers that need to be operated on; and
providing the operation to the browser process or client operation process corresponding to the one network server, and providing the virtual operations to the browser processes or client operation processes corresponding to the other network servers; and
wherein, the step of sending and the step of receiving are performed respectively by the corresponding browser processes or client operation processes.

3. The method as recited in claim 1, further comprising the step of:
presenting a response from the network software product instance on the one network server and responses from the network software product instances on the other network servers.

4. The method as recited in claim 3, further comprising the step of:
comparing the response from the network software product instance on the one network server and the responses from the network software product instances on the other network servers, and the step of presenting is further configured to present the results of the comparison.

5. The method as recited in claim 1, further comprising the step of:
specifying the one network server on which the network software product instance is to be operated and the other network servers on which the network software product instances the equivalent requests are to be transmitted to, wherein the step of specifying the other network servers comprises specifying all or any part of the plurality of network servers.

6. The method as recited in claim 1, further comprising the step of switching to an asynchronous mode in which the equivalent requests will not be transmitted automatically to the network software product instances on the other network servers, and the step of switching back from the asynchronous mode; and/or the step of switching the one network server on which the network software product instance is to be operated to any of the other network servers.

7. The method as recited in claim 4, wherein the step of comparing comprises generating the display interfaces of the responses from the network software product instances on the network servers, and comparing the images of the display interfaces point by point.

8. The method as recited in claim 4, wherein the step of comparing further comprises the steps of:
generating the display interfaces of the responses;
identifying objects and controls in the display interfaces; and
performing the comparison based on the mapping relationships between the objects and controls in the display interfaces.

9. A method as recited in claim 1, further comprising:
performing testing operations using the steps of method 1 for testing a network software product, wherein a plurality of instances of the network software product are deployed on a plurality of network servers.

10. An apparatus for parallel network operations on a network software product deployed on a plurality of network servers, the apparatus comprising:
an interface module through which operations are performed on the network software product instance on one network server of the plurality of network servers;
a generation module for generating a first request to the network software product instance on the one network server based on the operation, and equivalent requests to the network software product instances on the other network servers of the plurality of network servers;
a sending module for sending the first request to the network software product instance on the one network server, and for sending the equivalent requests to the network software product instances on the other network servers; and
a receiving module for receiving a response from the network software product instance on the one network server and responses from the network software product instances on the other network servers.

11. The apparatus as recited in claim 10, wherein the generation module is further configured to:
create a separate browser process or client operation process for each network server of the plurality of network servers that needs to be operated on;
wherein, the generation module generates a first request to the network software product instance on the one network server based on the operation, and equivalent requests to the network software product instances on the other network servers in the plurality of network servers by:
intercepting the operation, and converting the operation into virtual operations on the network software product instances on the other network servers in the plurality of network servers that need to be operated on; and
providing the operation to the browser process or client operation process corresponding to the one network server, and providing the virtual operations to the browser processes or client operation processes corresponding to the other network servers; and
wherein, the sending module and the receiving module are implemented respectively by the corresponding browser processes or client operation processes.

12. The apparatus as recited in claim 10, further comprising a presenting module for presenting a response from the network software product instance on the one network server and responses from the network software product instances on the other network servers.

13. The apparatus as recited in claim 12, further comprising a comparison module for comparing the response from the network software product instance on the one network server and the responses from the network software product instances on the other network servers, and the presenting module is further configured to present the results of the comparison.

14. The apparatus as recited in claim 10, further comprising a configuration module for specifying the one network server on which the network software product instance is to be operated and the other network servers on which the network software product instances the equivalent requests are to be transmitted to, wherein specifying the other network servers comprises specifying all or any part of the plurality of network servers.

15. The apparatus as recited in claim 10, further comprising a switching module for switching to an asynchronous mode in which the equivalent requests will not be transmitted automatically to the network software product instances on the other network servers; and the switching module is further configured to switch back from the asynchronous mode; and/or switch the one network server on which the network software product instances is to be operated to any of the other network servers.

16. The apparatus as recited in claim 13, wherein the comparison module is further configured to:
generate the display interfaces of the responses from the network software product instances on the network servers, and compare the images of the display interfaces point by point.

17. The apparatus as recited in claim 13, wherein the comparison module is further configured to:
generate the display interfaces of the responses;
identify objects and controls in the display interfaces; and
perform the comparison based on the mapping relationships between the objects and controls in the display interfaces.

18. The apparatus as recited in claim 10, wherein the apparatus is implemented by any of a network browser plug-in, a separate network browser, a network browser using the IE core, a client requesting apparatus plug-in, or a proxy server.

19. The apparatus as recited in claim 10, wherein the apparatus is a component of a system for testing a network software product, wherein a plurality of instances of the network software product are deployed on a plurality of network servers.

20. A computer program product comprising a computer readable recording medium with computer readable code stored thereon comprising computer executable instructions, said computer executable instructions causing a machine to perform the steps of:
performing an operation on an instance of a network software product on one network server of a plurality of network servers;
generating a first request to the network software product instance on the one network server based on the operation, and equivalent requests to the network software product instances on other network servers of the plurality of network servers;
sending the first request to the network software product instance on the one network server, and sending the equivalent requests to the network software product instances on the other network servers; and
receiving a response from the network software product instance on the one network server and responses from the network software product instances on the other network servers.
